(19) United States
(12) Patent Application Publication
(10) Pub. No.: US 2016/0300516 A1
(43) Pub. Date: Oct. 13, 2016

(54) PROJECTION DISPLAY

(71) Applicant: HYUNDAI MOTOR COMPANY, Seoul (KR)

(72) Inventor: HeeJin RO, Seoul (KR)

(21) Appl. No.: 14/933,809

(22) Filed: Nov. 5, 2015

(30) Foreign Application Priority Data
Apr. 7, 2015 (KR) 10-2015-0049108

(51) Int. Cl. G09G 3/00; G06F 3/042; G03B 21/28; G03B 21/56; G03B 21/14

(52) U.S. Cl. CPC G09G 3/002; G03B 21/56; G03B 21/142; G03B 21/28; G06F 3/0425; G09G 2360/04

(57) ABSTRACT

A projection display includes a screen in which a first area is constituted by an openable screen, an air-conditioning duct in which an outlet is opened and closed by the openable screen, and a projection module projecting an image to the screen, wherein the openable screen operates as the screen to which the image is projected in a closed state and operates an outlet of the air-conditioning duct in an opened state.

### CROSS-REFERENCE TO RELATED APPLICATION

This application claims the benefit of priority to Korean Patent Application No. 10-2015-0049108, filed in the Korean Intellectual Property Office on Apr. 7, 2015, the entire contents of which are incorporated herein by reference.

### TECHNICAL FIELD

The present disclosure relates to a projection display.

### BACKGROUND

In recent years, vehicles including a vehicular display for displaying various pieces of information including temperature information, audio associated information, navigation information, digital multimedia broadcasting (DMB) information, and the like in the vehicles has become common. Further, while the types and size of information to be displayed on the vehicular display increases, a vehicular display including a panorama type of display, in which a cluster and a center fascia are integrated, has become gradually enlarged.

Meanwhile, when the panorama type display is implemented by integrating the cluster and the center fascia, there is a limit in the freedom to position an air-conditioning duct, and as a result, a driver's seat air-conditioning duct positioned at the center fascia side in the related art needs to move to a lower end of the display or be eliminated. However, the positional change or elimination of the driver's seat air-conditioning duct may degrade in-vehicle air-conditioning performance, and as a result, convenience and functionality of the vehicle may deteriorate.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide a display which can be coupled integrally with an air-conditioning duct.

An exemplary embodiment of the present disclosure provides a projection display including: a screen in which a first area is constituted by an openable screen; an air-conditioning duct in which an outlet is opened/closed by the openable screen; and a projection module projecting an image to the screen, in which the openable screen operates as the screen to which the image is projected in a closed state and operates as an outlet of the air-conditioning duct in an opened state.

According to exemplary embodiments of the present disclosure, an openable screen is coupled to an outlet of an air-conditioning duct and it is controlled such that the openable screen performs a function as a screen to which an image is projected and a function as a discharge hole of the air-conditioning duct in parallel to enlarge a display while maintaining a function of the air-conditioning duct.

### BRIEF DESCRIPTION OF THE DRAWINGS

FIG. 1 is a schematic structural diagram of a projection display according to an exemplary embodiment of the present disclosure.

FIGS. 2A and 2B are schematic perspective views of an openable screen according to the exemplary embodiment of the present disclosure.

FIG. 3 is a schematic cross-sectional view of a light blocking member according to the exemplary embodiment of the present disclosure.

FIGS. 4A and 4B are diagrams schematically illustrating an operation of an opening/closing sensor according to the exemplary embodiment of the present disclosure.

FIG. 5 is a flowchart schematically illustrating a method for controlling a projection display according to another exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

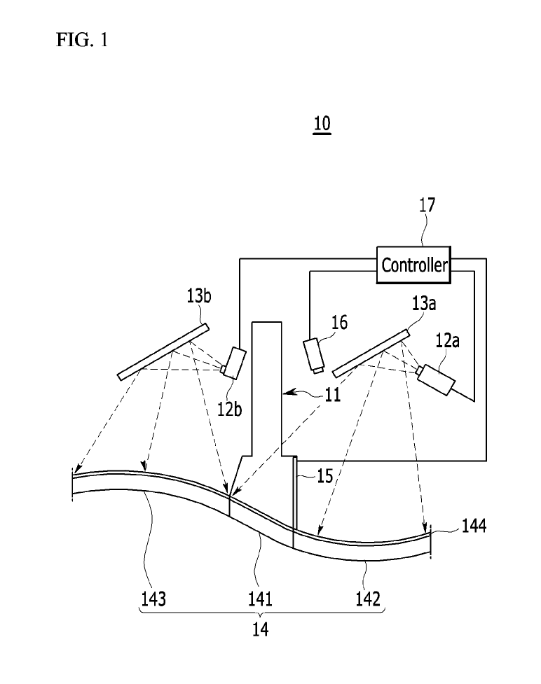

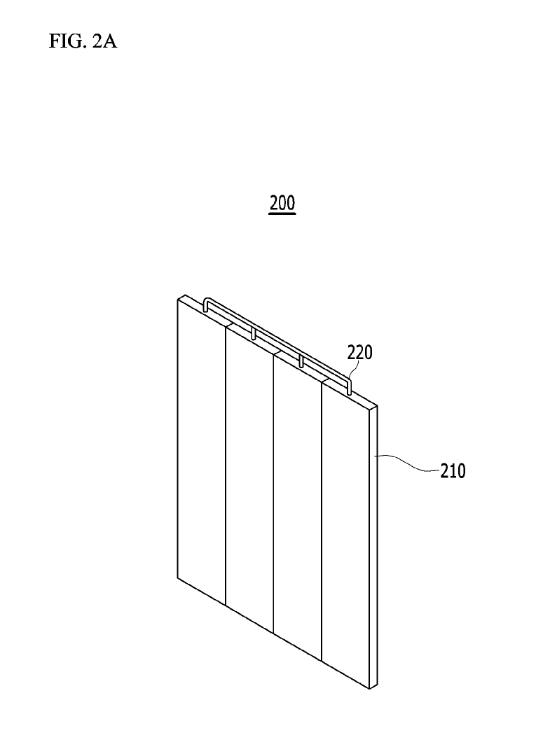

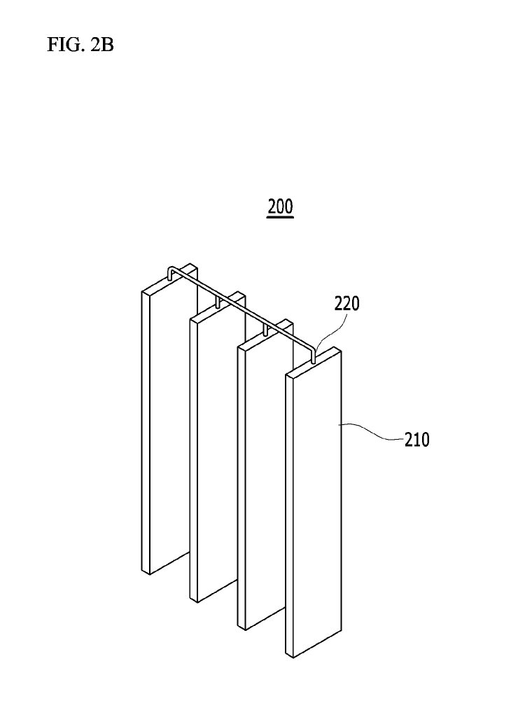

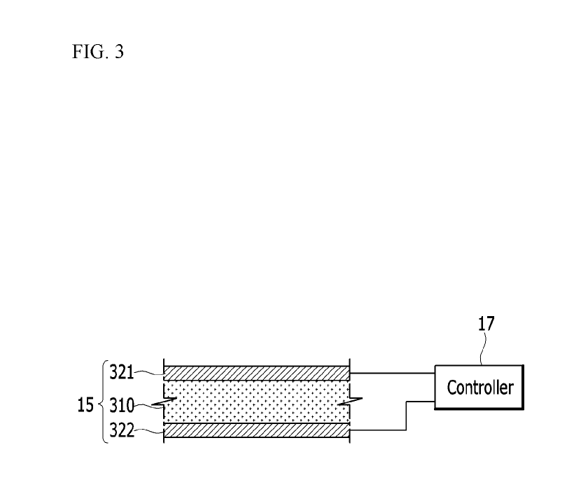

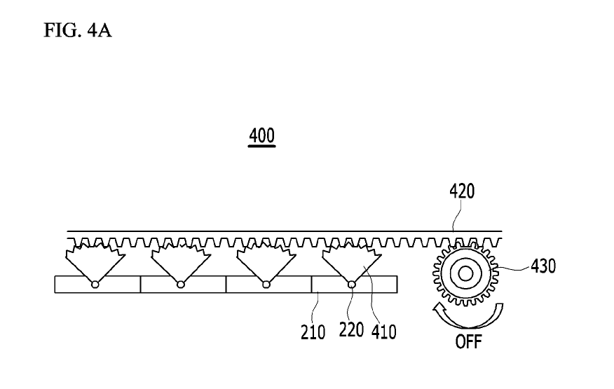

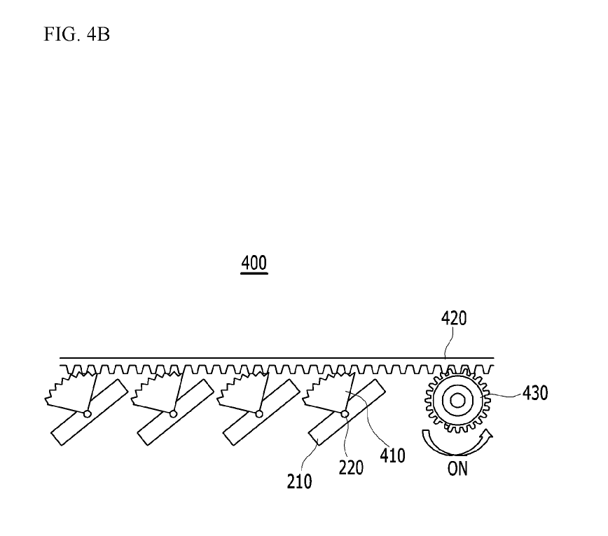

FIG. 1 is a schematic structural diagram of a projection display according to an exemplary embodiment of the present disclosure. FIGS. 2A and 2B are schematic perspective views of an openable screen according to the exemplary embodiment of the present disclosure, and are diagrams illustrating a closed state and an opened state of the openable screen, respectively. FIG. 3 is a schematic cross-sectional view of a light blocking member according to the exemplary embodiment of the present disclosure. FIGS. 4A and 4B are diagrams schematically illustrating an operation of an opening/closing sensor according to the exemplary embodiment of the present disclosure.

Referring to FIG. 1, a projection display 10 may include an air-conditioning duct 11, a plurality of projection modules 12a and 12b, a plurality of reflection members 13a and 13b, a screen 14, a light blocking member 15, a camera 16 and a controller 17.

The air-conditioning duct 11 is a structure that performs a function as a passage through which air (cold airflow/warm airflow) supplied from an air-conditioner (not illustrated) flows. In the air-conditioning duct 11, an outlet contacts a partial area of a rear surface of the screen 14 to be opened/closed by the screen 14.

The plurality of projection modules 12a and 12b may be deployed in the rear of the screen 14 and radiate an image (light) to different areas of a rear surface of the screen 14. Meanwhile, in FIG. 1, a case in which the plurality of projection modules 12a and 12b is included in order to implement a panorama type of projection display 10 with the screen 14 having a large size is illustrated as an example, but the exemplary embodiment of the present disclosure is not limited thereto. The number of projection modules constituting the projection display may vary depending on the size of the projection display.

Each of the reflection members 13a and 13b is deployed on an image projection path of each of the projection modules 12a and 12b. Each of the reflection members 13a and 13b controls the projection path of the image radiated from each of the projection modules 12a and 12b to transfer the image projected from each of the projection modules 12a and 12b to the rear surface of the screen 14. An installation position and an installation angle of each of the reflection members 13a and 13b may be controlled so that the image projected from each of the projection modules 12a and 12b is formed on the screen 14. Meanwhile, in FIG. 1, a case in which one reflection member 13a or 13b is deployed between each of the projection modules 12a and 12b and the screen 14 is illustrated as an example, but the exemplary embodiment of the present disclosure is not limited thereto. According to a relative position of each of the projection modules 12a and 12b and the screen 14, the reflection member may be omitted or a plurality of reflection members may be deployed between each of the projection modules 12a and 12b and the screen 14.

The reflection members 13a and 13b may include a mirror.

The image radiated from each of the projection modules 12a and 12b may be projected on the screen 14.

The screen 14 is a rear projection screen that allows the image radiated to the rear of the screen 14 to be viewed at the front of the screen 14. A projection film 144 may be coupled to the rear surface of the screen 14 so that the image projected from the rear of the screen 14 is projected on the screen 14 to be viewed at the front of the screen 14.

The screen 14 may include a first area 141 in which the outlet of the air-conditioning duct 11 is coupled to the rear surface of the screen 14, and a second area 142 and a third area 143 deployed at respective sides of the first area 141.

The first area 141 as an air-conditioning area may perform a function as a screen on which the image projected from the projection module 12a is formed and a function as an outlet to control a discharge amount and a discharge direction of air transferred through the air-conditioning duct 11 by opening/closing the air-conditioning duct 11. To this end, the first area 141 may be implemented by an openable screen (see reference numeral 200 of FIG. 2) which is openable/closable by external force.

Referring to FIGS. 2A and 2B, the openable screen 200 which has a blind shape may include a plurality of blades 210 integrally coupled to a rotational shaft 220. Each blade 210 is rotated by an external force to open or close the outlet of the air-conditioning duct 11. FIG. 2A illustrates a state in which the outlet of the air-conditioning duct 11 is closed by the blades 210, and FIG. 2B illustrates a state in which the outlet of the air-conditioning duct 11 is opened by the blades 210.

In the exemplary embodiment of the present disclosure, the openable screen 200 performs the screen function of forming the image projected from the projection module 12a in the state where the air-conditioning duct 11 is closed by the blades 210.

On the contrary, the openable screen 200 operates as the outlet that controls the discharge amount and the discharge direction of the air transferred through the air-conditioning duct 11 in the state where the blades 210 rotate to open the air-conditioning duct 11. In this case, the discharge amount and the discharge direction of the air transferred through the air-conditioning duct 11 may be controlled according to a rotational angle of each blade 210.

The second area 142 as an area corresponding to a center fascia that operates as a control pad of a vehicle may perform the screen function of forming the image projected from the projection module 12a and a function as a touch screen that receives a touch input for controlling a navigation unit, an air-conditioner, or another device. To this end, the camera 16 is deployed in the rear of the second area 142 and a touch image for the second area 142 is photographed through the camera 16.

The third area 143 as an area corresponding to an instrument cluster of the vehicle serves as the screen on which the image projected from the projection module 12b is formed.

The light blocking member 15 is a switchable optical shutter panel in which optical transmittance (transparency) is controlled. That is, the optical transmittance (transparency) is controlled according to a control signal (electrical signal) input from the controller 17, and as a result, the light blocking member 15 passes or blocks an image (light) reflected and input by the reflection member 13a. To this end, the light blocking member 15 may include a material (see reference numeral 310 of FIG. 3) of which optical transmittance is controlled by the electrical signal input from the controller 17.

Referring to FIG. 3, the light blocking member 15 may include first and second electrodes 321 and 322 deployed to be separated from each other, and a light blocking material 310 interposed between the first and second electrodes 321 and 322. Optical transmittance of the light blocking material 310 is controlled by an electrical signal applied to the first and second electrodes 321 and 322 from the controller 17. Liquid crystal, an electrochromic material, and the like may be used as the light blocking material 310. The liquid crystal as an organic compound having an intermediate property of liquid and crystal in a predetermined temperature range is a material of which a color or transparency varies depending on a voltage or a temperature. The electrochromic material is an element of which the color or transparency of the material varies depending on an oxidation/reduction reaction by applying a voltage.

The light blocking member 15 may be deployed on a path through which the image (light) reflected by the reflection member 13a is radiated to a partial area of the screen 14, that is, the first area 141. Since the first area 141 is coupled to an opening of the air-conditioning duct 11, the light blocking member 15 may be integrally coupled to the air-conditioning duct 11 so that the radiated image passes through the inside of the air-conditioning duct 11 to be transferred to the openable screen 200 of the first area 141.

The camera 16 is deployed in the rear of the screen 14 and photographs a touch image for a partial area of the screen 14, that is, the second area 142 in the rear of the screen 14. The touch image photographed by the camera 16 is transferred to the controller 17.

The controller 17 controls an overall operation of the projection display 10.

The controller 17 may control the optical transmittance (transparency) of the light blocking member 15 according to an opened/closed state of the openable screen 200. That is, the controller 17 may control the light blocking member 15 so as to transmit or block the image radiated from the projection module 12a according to the opened/closed state of the openable screen 200. For example, the controller 17 transparently controls the optical transmittance of the light blocking member 15 so that the light radiated from the projection module 12a is transferred to the openable screen 200 in the closed state of the openable screen 200. Further, for example, the controller 17 opaquely controls the optical transmittance of the light blocking member 15 so that the light radiated from the projection module 12a is not transferred to the openable screen 200 in the opened state of the openable screen 200.

Meanwhile, when the openable screen 200 is opened/closed by a manual operation of a user, the projection display 10 may further include an opening/closing sensor (see reference numeral 400 of FIGS. 4A and 4B) for sensing the opened/closed state of the openable screen 200.

Referring to FIGS. 4A and 4B, the openable sensor 400 may include a pinion 410, a rack rail 420, and a rotary switch 430. The pinion 410 may be integrally coupled to the rotational shaft 220 of the openable screen 200 and rotate in link with rotation of the rotational shaft 220. That is, when the rotational shaft 220 rotates by rotation of the blade 210, the pinion 410 may rotate in link with the rotation of the rotational shaft 220.

The pinion 410 and at least one sawtooth of the rack rail 420 may engage with each other and the rack rail 420 may linearly move in link with a rotating motion of the pinion 410. That is, when the pinion 410 rotates, the rack rail 420 may move in a linear direction in link with the rotation of the pinion 410 due to sawtooth engagement with the pinion 410.

The rack rail 420 and at least one sawtooth of the rotary switch 430 may engage with each other and the rotary switch 430 may rotate in link with the linear motion of the rack rail 420. That is, when the rack rail 420 moves in the linear direction due to the sawtooth engagement with the rack rail 420, the rotary switch 430 may rotate in link with the linear movement of the rack rail 420.

Consequently, the rotary switch 430 may rotate in link with the rotation of the blade 210 of the openable screen 200 and be turned on/off according to the rotational direction. When FIG. 4A is given as an example, the rotary switch 430 may be switched to an off state as the rotary switch 430 rotates in a direction in which the blade 210 of the openable screen 200 is closed. On the contrary, when FIG. 4B is given as an example, the rotary switch 430 may be switched to an on state as the rotary switch 430 rotates in a direction in which the blade 210 of the openable screen 200 is opened. As a result, the controller 17 may sense the opened/closed state of the openable screen 200 according to the on/off state of the rotary switch 430.

The controller 17 may control the projection modules 12a and 12b to output the image corresponding to each of the areas 141, 142, and 143 of the screen 14.

The controller 17 may control the image output through the projection module 12a according to an existence of information projected to the openable screen 200 and the opened/closed state of the openable screen 200. For example, the controller 17 may process an area projected to the openable screen 200 among the images output through the projection module 12a by a specific color (e.g., a black color) when there is no information to be displayed on the openable screen 200 or the openable screen 200 is in the opened state.

The controller 17 may detect touch coordinates from the touch image acquired through the camera 16 and perform a corresponding control command based on the detected touch coordinates.

The controller 17 may change projected images projected through the projection modules 12a and 12b according to the opened/closed state of the openable screen 200.

The controller 17 may correct the projected image so that information displayed in the air-conditioning area 141 of the screen 14 in the projected image, that is, the area corresponding to the openable screen 200, moves to other areas 142 and 143 to be projected when the openable screen 200 is in the opened state.

The controller 17 may change the information displayed in the projected image according to the opened/closed state of the openable screen 200. For example, the projected image may be configured to include a set temperature of an air-conditioner (not illustrated) in the opened state of the openable screen 200, and the projected image may be configured to include temperature and weather information outside the vehicle in the closed state of the openable screen 200.

Meanwhile, in the exemplary embodiment of the present disclosure, a case in which the projection display 10 is used as a vehicular display is illustrated as an example, but the exemplary embodiment of the present disclosure is not limited thereto. The projection display 10 having the aforementioned structure may be used as a display in another electronic apparatus including an air-conditioning unit such as an air-conditioner, or the like.

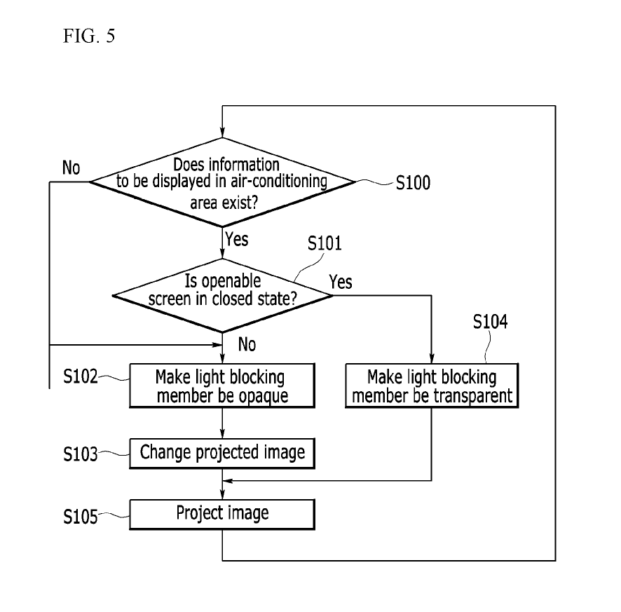

FIG. 5 is a flowchart schematically illustrating a method for controlling a projection display according to another exemplary embodiment of the present disclosure.

Referring to FIG. 5, the projection display 10 according to the exemplary embodiment of the present disclosure may analyze an image to be projected through the projection module 12a to determine whether there is information to be displayed in the air-conditioning area 141 of the screen 14 (S100).

In step S100, when there is no information to be displayed in the air-conditioning area 141, the projection display 10 controls the optical transmittance of the light blocking member 15 in an opaque state regardless of the opened/closed state of the openable screen 200 (S102). Further, information on the area corresponding to the air-conditioning area 141 of the screen 14 in the image to be projected to the screen 14 is removed and is filled with the specific color (e.g., the black color) to change the projected image (S103). In addition, the changed projected image is projected to the screen 14 by controlling the projection modules 12a and 12b (S105).

On the contrary, in step S100, when there is information to be displayed in the air-conditioning area 141 of the screen 14, the projection display 10 may determine whether the openable screen 200 is in the closed state based on a sensing result of the opening/closing sensor 400 (S101).

In step S101, when the openable screen 200 is in the opened state, the projection display 10 controls the optical transmittance of the light blocking member 15 in the opaque state (S102). Further, the information on the area corresponding to the air-conditioning area 141 of the screen 14 in the image to be projected to the screen 14 is removed and is filled with the specific color (e.g., the black color) to change the projected image (S103). In addition, the changed projected image is projected to the screen 14 by controlling the projection modules 12a and 12b (S105).

Meanwhile, in step S103, the projection display 10 may correct the projected image so that the information to be displayed in the air-conditioning area 141 is displayed in the areas 142 and 143 other than the air-conditioning area 141 when the openable screen 200 is opened while the information to be displayed in the air-conditioning area 141 is included in the projected image.

Again, in step S101, when the openable screen 200 is in the closed state while the information to be displayed in the air-conditioning area 141 is included in the projected image, the projection display 10 controls the optical transmittance of the light blocking member 15 in a transparent state (S104). In addition, the image is projected to the screen 14 by controlling the projection modules 12a and 12b (S105).

As described above, according to the exemplary embodiments of the present disclosure, the openable screen is coupled to the outlet of the air-conditioning duct, and the openable screen controls the function of the screen to which an image is projected and the function as the discharge hole of the air-conditioning duct to be used in parallel to enlarge the display while maintaining the function of the air-conditioning duct.

Further, while the openable screen is opened and the air-conditioning-duct is thus opened, the image projected to the openable screen is blocked through the light blocking member, and as a result, the image is transferred to a user's eyes through the opening of the openable screen, thereby preventing the user's attention from being distributed.

The control method of the projection display according to the exemplary embodiments of the present disclosure may be executed through software. When the control method is executed by the software, constituent means of the present disclosure are code segments that execute required operations. A program or code segment may be stored in a processor-readable medium or transmitted by a transmission medium or a computer data signal coupled with a carrier on a communication network.

A computer-readable recording medium includes every type of recording devices in which data readable by a computer system processor is stored. Examples of the computer-recordable recording medium include a ROM, a RAM, a CD-ROM, a DVD-ROM, a DVD-RAM, a magnetic tape, a floppy disk, a hard disk, an optical data storage device, and the like. Further, the computer-readable recording medium may be distributed in computer systems connected through a network, and a computer-readable code may be stored therein and executed in a distributed manner.

The drawings referred to and the detailed description of the present disclosure disclosed up to now are just exemplary in the present disclosure, and they are used for describing the present disclosure but not used to limit a meaning or limit the scope of the present disclosure disclosed in the claims. Therefore, those skilled in the art can easily select and substitute the drawings and the detailed description therefrom. Further, those skilled in the art can omit some of components described in the specification without deterioration of performance and add components in order to improve performance. Moreover, those skilled in the art can change the order of steps of the method described in the specification according to a process environment or equipment. Accordingly, the scope of the present disclosure should be determined not according to the described exemplary embodiment, but according to the appended claims and equivalents thereto.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A projection display comprising:
a screen in which a first area is constituted by an openable screen;
an air-conditioning duct in which an outlet is opened and closed by the openable screen; and
a projection module projecting an image to the screen,
wherein the openable screen operates as the screen to which the image is projected in a closed state and operates an outlet of the air-conditioning duct in an opened state.

2. The projection display of claim 1, further comprising
a light blocking member deployed on a path through which the image is radiated to the openable screen, in which optical transmittance is controlled according to the opened and closed state of the openable screen.

3. The projection display of claim 2, further comprising:
an opening and closing sensor sensing the opened and closed state of the openable screen; and
a controller controlling the optical transmittance of the light blocking member according to the opened and closed state of the openable screen.

4. The projection display of claim 2, wherein the optical transmittance of the light blocking member is controlled in a transparent state so as to pass the image in the closed state of the openable screen and the optical transmittance of the light blocking member is controlled in an opaque state so as to block the image in the opened state of the openable screen.

5. The projection display of claim 4, wherein the light blocking member includes first and second electrodes, and a light blocking material interposed between the first and second electrodes, of which optical transmittance is controlled according to an electrical signal applied to the first and second electrodes.

6. The projection display of claim 3, wherein the openable screen has a blind shape including a plurality of blades which rotate by external force to open and close the outlet of the air-conditioning duct.

7. The projection display of claim 6, wherein the opening and closing sensor includes a rotary switch which rotates in link with the rotation of the blade and is turned on and off according to a rotational direction.

8. The projection display of claim 7, wherein the opening and closing sensor further includes a pinion which is integrally coupled to a rotational shaft of the blade and rotates in link with the rotation of the blade, and a rack rail which linearly moves in link with the rotating motion of the pinion,
wherein the rack rail and at least one sawtooth of the rotary switch engage with each other, and as a result, the rotary switch rotates in link with a linear motion of the rack rail.

9. The projection display of claim 1, further comprising a controller adjusting information of an area corresponding to the openable screen in the image according to the opened and closed state of the openable screen.

10. The projection display of claim 9, wherein the controller moves the information of the area corresponding to the openable screen in the image to other areas of the screen when the openable screen is in the opened state.

11. The projection display of claim 9, wherein the controller changes the information included in the image when the openable screen is in the opened state.

12. The projection display of claim 9, wherein the controller changes the area corresponding to the openable screen in the image to a specific color when the image does not include the information to be displayed on the openable screen.

13. The projection display of claim 1, wherein the screen includes a second area that operates as a touch screen.

14. The projection display of claim 13, further comprising:
a camera deployed in the rear of the screen and photographing a touch image for the second area; and
a controller analyzing the touch image to detect touch coordinates.

15. The projection display of claim 1, further comprising at least one reflection member deployed on a projection path of the projection module and controlling the projection path of the image projected from the projection module to transfer the image to the screen.
